(19) United States
(12) Patent Application Publication
(10) Pub. No.: US 2023/0118062 A1
(43) Pub. Date: Apr. 20, 2023

(54) GRID OF A PLURALITY OF BUILDING TECHNOLOGY SENSOR MODULES AND SYSTEM COMPRISING SUCH A GRID

(71) Applicant: Tridonic GmbH & Co KG, Dornbirn (AT)

(72) Inventor: Istvan Bakk, Dornbirn (AT)

(73) Assignee: Tridonic GmbH & Co KG, Dornbirn (AT)

(21) Appl. No.: 17/910,156

(22) PCT Filed: Mar. 11, 2021
(86) PCT No.: PCT/EP2021/056173

§ 371 Date: Sep. 8, 2022

(30) Foreign Application Priority Data
Mar. 11, 2020 (EP) 20162321.2

(51) Int. Cl. H04L 67/125; H05B 47/115; H05B 47/11; H05B 47/19; H04L 12/28; G05B 19/042

(52) U.S. Cl. CPC H04L 67/125; H05B 47/115; H05B 47/11; H05B 47/19; H04L 12/2803; G05B 19/042; G05B 2219/25011

(57) ABSTRACT

The invention relates to a system (400) comprising a data processing unit (402) and/or a central database (403), and a grid (100) of a plurality of building technology sensor modules (101a-d). Each of the sensor modules (101a-d) comprises light sensor (103), preferably a daylight sensor, an acoustic sensor (105), a motion sensor (107), a controller (109) which is configured to receive output signals from said sensors (103, 105, 107), and an interface, preferably a wireless interface (111), for a communication between the controller (109) and a gateway (401) for forwarding sensor information signals (130) to the data processing unit (402) and/or the central database (403), wherein said sensor information signals (130) comprise a timestamp, an identifier of a sensor module (101a-d) and a sensor value. The data processing unit (402) and/or the central database (403) carry out a first data analysis of the forwarded sensor information signals (130), preferably by machine learning, for evaluating correlations between sensor information signals (130) of sensors (103, 105, 107) of different categories and/or of different sensor modules (101a-d), wherein the system (400) is designed to detect incorrect data provided by one or more sensors (103, 105, 107) based on the first data analysis, and to ignore, replace or correct such incorrect data.

### CROSS REFERENCE TO RELATED APPLICATIONS

The present application is the U.S. national stage application of international application PCT/EP2021/056173 filed Mar. 11, 2021, which international application was published on Sep. 16, 2021 as International Publication WO 2021/180843 A1. The international application claims priority to European Patent Application No. 20162321.2 filed Mar. 11, 2020.

### TECHNICAL FIELD OF THE INVENTION

The invention relates to a system comprising a grid of a plurality of building technology sensor modules. The invention further relates to a method for operating such a grid.

### BACKGROUND OF THE INVENTION

Many environments, such as buildings, comprise various sensors e.g. motion sensors or noise sensors, which are distributed in the environment to collect environmental information, e.g. information about the presence of people or a noise level in the environment. This information can be used to control a luminaire grid or other building systems.

However, it is difficult and costly to distribute, network and power a sufficient number of different environmental sensors, especially in a large environment.

Thus, it is an objective of the invention to provide an improved system comprising a grid of a plurality of building technology sensor modules and an improved method for operating such a grid, which avoid the above-mentioned disadvantages. In particular, it is an objective to collect environmental information efficiently and in a cost effective manner.

### SUMMARY OF THE INVENTION

The object of the present invention is achieved by the solution provided in the enclosed independent claims. Advantageous implementations of the present invention are further defined in the dependent claims.

According to a first aspect, the invention relates to a a data processing unit and/or a central database; and a grid of a plurality of building technology sensor modules, each of the sensor modules comprising a light sensor, preferably a daylight sensor, an acoustic sensor, a motion sensor, a controller which is configured to receive output signals from said sensors, and a interface, in particular a wireless interface, for a communication between the controller and a gateway for forwarding sensor information signals to the processing unit and/or the central database, wherein said sensor information signals comprise a timestamp, an identifier of a sensor module and a sensor value; wherein the data processing unit and/or the central database carry out a first data analysis of the forwarded sensor information signals, preferably by machine learning, for evaluating correlations between sensor information signals of sensors of different categories and/or of different sensor modules, and wherein the system is designed to detect incorrect data provided by one or more sensors based on the first data analysis, and to ignore, replace or correct such incorrect data.

This provides the advantage that environmental information can be collected efficiently. Furthermore, due to its ability to detect incorrect data, the system has a high robustness.

The system may further comprise the gateway, i.e. the gateway can be an element of the system.

Integrating various sensors in each sensor module of the grid, allows collecting a large number of sensor data of different sensor types and from various places in the environment. By evaluating this data, a lot of information about the environment can be gained, e.g. about the distribution and movement of people in the environment. At the same time, costs can be reduced by sharing the housing, communication means and/or power sources between the sensors in each module.

Preferably, the building technology sensor modules are sensor modules that are connected to a lighting control network, such as a DALI or wireless network, of a building, in particular via the interface. The sensor modules can be configured for controlling luminaires connected to the lighting control network.

Throughout the document, the phrase “sensor modules” refers to the “building technology sensor modules”.

The fact that the sensor information signals comprises a timestamp, an identifier (ID) of a sensor module and a sensor value achieves the advantage that each sensor information signal can be correlated to a place in the environment and a time. For instance, this enables determining at which time people are present in a certain place in the environment, e.g. a certain room.

In particular, sensor information signals comprise a plurality of timestamps, identifiers (ID) of sensor modules and sensor values.

The output signals received by the controller may refer to the sensor values/readings that are outputted by the sensors, i.e. the amplitude. The sensor information signals can inter alia comprise the output signals of the sensors.

For example, the system is designed to detect incorrect data from one of the sensors, e.g. incorrect sensor values/readings, based on a deviation of the sensor values from said sensor from an average of the sensor values of other (adjacent) sensors of the grid by more than a threshold value.

Alternatively, the system may detect the incorrect data based on a standard deviation of the sensor values from one sensor being smaller than a threshold value, i.e. the sensor signal from this sensor is too stable. Further, the course of a sensor signal from one sensor of the grid over time is detected as irregular due to, e.g., too little signal change over time.

Preferably, the data processing unit and/or the central database of the system are configured to detect the incorrect data provided by the one or more sensors and to ignore, replace or correct such incorrect data.

In particular, the data processing unit and/or the central database can comprise a neural network, which is trained to detect correct or incorrect temporal signal characteristics.

The processing unit and/or the central database can be configured to detect the incorrect data provided by one or more sensors by analyzing the output signals, in particular sensor value/readings, from said by one or more sensors over a predetermined period of time.

In an embodiment, the grid comprises luminaires, wherein one, more or all of the sensor modules are integrated in or associated with the luminaires.

Since luminaires are typically evenly distributed over such an environment, integrating or associating each sensor module in respectively with a luminaire leads to a good coverage of the environment with the sensors.

In particular, the grid comprises a number of luminaires, wherein each sensor module of the grid is associated with or integrated in a respective luminaire of the number of luminaires. The number of luminaires can form a luminaire grid, wherein the grid of the plurality of building technology sensor modules can comprise the luminaire grid.

In an embodiment, the sensors and the respective controllers of the one, more or all sensor modules are placed on circuit boards of the luminaires, wherein preferably the circuit boards are provided with a plurality of LEDs.

This achieves the advantage that the sensors in the luminaires have a low profile and can use existing power supplies and/or communication means of the luminaires. Thus, each luminaire may simultaneously function as a sensor and a light source, which leads to an overall cost reduction.

In an embodiment, the sensors and the controller of the one, more or all sensor modules are arranged within housings of the luminaires, preferably below diffusing plates.

This achieves the advantage that costs can be reduced by using shared housings for luminaires and sensors.

In an embodiment, the luminaires are downlights, pending luminaires or freestanding luminaires.

This provides the advantage that the environment can be illuminated efficiently.

In an embodiment, the controller is arranged for forwarding the sensor information signals repetitively with a constant or a varying, especially adaptive, frequency.

This achieves the advantage that changes in the environment over time can be observed.

In an embodiment, the sensor value represents a parameter value, preferably an amplitude, of the output signal at the time of the associated timestamp.

This achieves the advantage that sensor values that are sufficient to detect changes in the environment can be forwarded to the database. In particular, only isolated sensor values, e.g. a noise level every few seconds, but no direct voice or video recordings are forwarded by the sensor modules due to hardware restrictions in the sensor modules.

In an embodiment, the interface is configured to forward the sensor information signals using a communication protocol, preferably the Bluetooth standard, the ZigBee standard or the Thread standard.

The system can further comprise the luminaires, wherein one, more or all the building technology sensor modules are integrated in or associated with the luminaires.

Preferably, the sensor fusion, i.e. the combination and comparison of different types of sensor signals from different sensors by the system, allows determining additional information about the environment with low uncertainty.

In an embodiment, the data processing unit and/or the central database carry out a second data analysis of the forwarded sensor information signals for evaluating the time development of one or more sensor information signals.

This achieves the advantage that additional information about the environment, e.g. movement patterns within the environment or typical times at which people are present in certain areas, can be determined based on sensor information signals.

Preferably, the system is designed to detect the incorrect data provided by the one or more sensors further based on said second data analysis.

In an embodiment, the system is designed to adapt an operation parameter of the system depending on the results of the first and/or second data analysis.

This achieves the advantage that the system has a high robustness, e.g. faulty sensor signals can be detected via comparison with signals from other sensors.

For instance, the frequency at which certain sensor modules are forwarding the sensor information signals can be adapted based on the results of the first and/or second data analysis.

In an embodiment, the system is designed to provide data of the system, in particular results of the first and/or second data analysis, to an external system, e.g. a building management system, a HVAC system, other a non-lighting system.

This achieves the advantage that external systems can be controlled efficiently based on the measurements of the sensor modules.

The central database can comprise a local storage, which is arranged in the environment of the grid, preferably in a building, and/or a remote storage, e.g. a cache server or a cloud storage. In particular, the local storage can collect the sensor information signals in real time locally.

According to a second aspect the invention relates to a method for operating a grid of a plurality of building technology sensor modules, each of the sensor modules comprising a light sensor, preferably a daylight sensor, an acoustic sensor, and a motion sensor, a controller, and an interface, preferably a wireless interface, the method comprising the steps of:

supplying output signals of said sensors to a controller,

establishing a communication connection between the controller and a gateway via the interface, and

forwarding sensor information signals to a data processing unit and/or a central database by means of the gateway, wherein said sensor information signals comprise a timestamp, an identifier of a sensor module and a sensor value;

wherein the data processing unit and/or the central database carry out a first data analysis of the forwarded sensor information signals, preferably by machine learning, for evaluating correlations between sensor information signals of sensors of different categories and/or of different sensor modules, and

wherein the system is designed to detect incorrect data provided by one or more sensors based on the first data analysis, and to ignore, replace or correct such incorrect data.

The above descriptions with regard to the system according to the first aspect of the invention are correspondingly valid for the method according to the second aspect of the invention.

### BRIEF DESCRIPTION OF THE DRAWINGS

The invention will be explained in the followings together with the figures.

FIG. 1 shows a schematic diagram of a grid of a plurality of building technology sensor modules according to an embodiment;

FIG. 2 shows a schematic diagram of a luminaire according to an embodiment;

FIG. 3 shows a schematic diagram of a luminaire according to a further embodiment;

FIG. 4 shows a schematic diagram of a system comprising a grid of building technology sensor modules according to an embodiment;

FIG. 5 shows a schematic diagram of a system comprising a grid of building technology sensor modules according to a further embodiment;

FIG. 6 shows a schematic diagram of a method for operating a grid of a plurality of building technology sensor modules according to an embodiment; and

FIGS. 7a-b show examples for sensor values comprising incorrect data according to further embodiments.

### DETAILED DESCRIPTION OF THE PREFERRED EMBODIMENTS

The present invention is described more fully hereinafter with reference to the accompanying drawings, in which various aspects of the present invention are shown. This invention however may be embodied in many different forms and should not be construed as limited to the various aspects of the present invention presented through this disclosure. Rather, these aspects are provided so that this disclosure will be thorough and complete, and will fully convey the scope of the present invention to those skilled in the art. The various aspects of the present invention illustrated in the drawings may not be drawn to scale. Rather, the dimensions of the various features may be expanded or reduced for clarity. In addition, some of the drawings may be simplified for clarity. Thus, the drawings may not depict all of the components of a given apparatus.

It is further understood that the aspect of the present invention might contain integrated circuits that are readily manufacturable using conventional semiconductor technologies, such as complementary metal-oxide semiconductor technology, short “CMOS”. In addition, the aspects of the present invention may be implemented with other manufacturing processes for making optical as well as electrical devices. Reference will now be made in detail to implementations of the exemplary aspects as illustrated in the accompanying drawings. The same references signs will be used throughout the drawings and the following detailed descriptions to refer to the same or like parts.

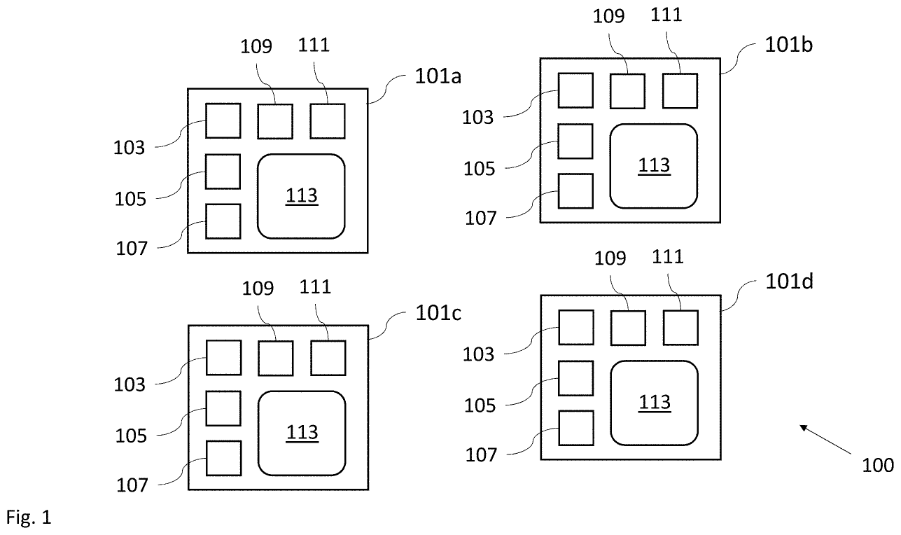

FIG. 1 shows a schematic diagram of a grid 100 of a plurality of building technology sensor modules 101a-d according to an embodiment.

Each of the building technology sensor modules 101a-d in the grid 100 comprises a light sensor 103, preferably a daylight sensor, an acoustic sensor 105, a motion sensor 107, a controller 109 supplied with the output signals of said sensors 103, 105, 107, and an interface 111 for a communication between the controller 109 and a gateway for forwarding sensor information signals to a processing unit and/or a central database (not shown in FIG. 1).

The grid 100 can be arranged in an environment, in particular a building.

Preferably, the interface 111 is configured to communicate with the gateway, in particular to forward the sensor information signals to the gateway. The interface 111 can be a wireless interface. Likewise, the gateway can be a wireless gateway.

The grid 100 can comprise luminaires, wherein the sensor modules 101a-d of the grid 100 can be integrated in or associated with the luminaires. Therefore, in the exemplary embodiment of FIG. 1, each sensor module 101a-d comprises a light source 113.

Since luminaires 101a-d are typically evenly distributed over an environment, equipping or associating each luminaires of a grid of luminaires with a sensor modules 101a-d leads to a good coverage of the environment with the sensors. Equipping luminaires with sensors has the additional advantage that no extra planning or manual commissioning for mounting external sensors in the environment has to be done.

Each of the luminaires can be a downlight luminaire, a standing luminaire or a freestanding luminaire. In particular, the grid 100 comprises different types of luminaires at different locations in the environment.

The controller 109 of each sensor module can be a micro controller unit (MCU).

Preferably, the controller 109 of each sensor module 101a-d is arranged for forwarding the sensor information signals repetitively with a constant or a varying, especially adaptive, frequency. In particular, the controller is configured to control the wireless interface 111 to forward the sensor information signals.

Preferably, the interface 111 of each sensor module 101a-d comprises a Bluetooth interface, a ZigBee interface and/or a Thread interface. The sensor information signals can be forwarded by the wireless interface 111 using the Bluetooth standard, the ZigBee and/or the Thread standard. In this way, the emitted sensor information signals can be received with a device, e.g. a smartphone, which can act as a gateway device.

The sensor information signals can comprise a timestamp, an identifier (ID) of the respective sensor module 101a-d and a sensor value. Via the timestamp and the identifier, the sensor value can be correlated to a place and time in the environment. In this way, a 2D mapping of the sensor values, e.g. anisotropic analog data, can be generated based on data stored in the central database. For instance, the 2D mapping shows a noise level or a brightness in the environment at different times during the day.

The acoustic sensor 105 of each sensor module 101a-d can be a noise detector. In particular, the acoustic sensor 105 is configured to detect a noise pressure level and/or noise patterns such as voice or burst sounds.

A sound pattern recognition function of the acoustic sensors 105 can be used to determine a probability of certain noise classes, e.g. chatter. In particular, the privacy of the people in the vicinity of the sensors can be assured by forwarding only one sound value every 1 to 4 seconds to the processing unit and/or the central database.

The motion sensor 107 can be a Doppler based motion sensor, i.e. a sensor that detects motion based on the Doppler effect. For example, the resolution of the presence/motion sensors 107 can indicate a magnitude of a motion within an environment.

The daylight sensor 103 can be configured to detect a natural light intensity, e.g. of sunlight.

In particular, all sensor readings can be forwarded to level 1 and level 2 data collection, storage and processing to the processing unit and/or the central database.

Preferably, the sensor value represents the amplitude of the sensor value at the time of the associated timestamp. For instance, the acoustic sensor periodically, e.g. every 5 seconds, provides the amplitude of a sound level, which can be used to determine if people are present in a certain room.

The grid 100 can comprise multiple sensor modules 101a-d equipped with the same type and number of sensors. Alternatively, sensor modules 101a-d of one grid 100 may comprise different sensors.

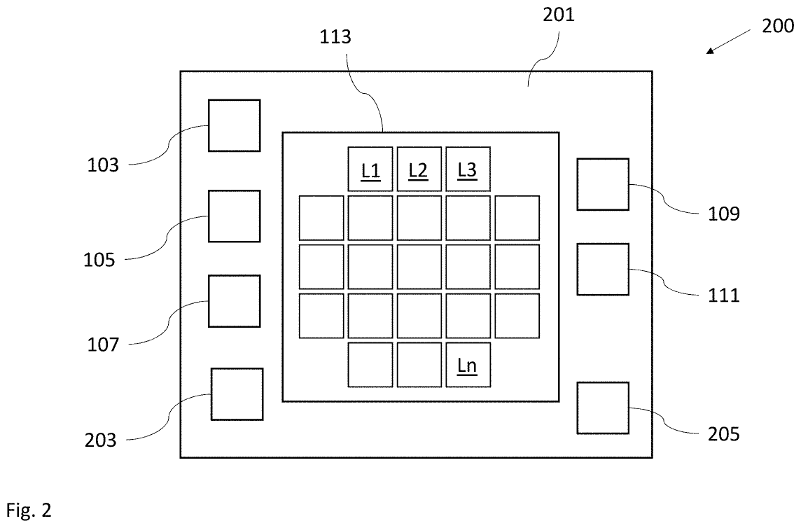

FIG. 2 shows a schematic diagram of a luminaire 200 according to an embodiment. In particular, FIG. 2 shows an exemplary embodiment of a luminaire 200 with an integrated sensor module 101a-d.

The luminaire 200, as shown in FIG. 2, comprises the light sensor 103, the acoustic sensor 105, the motion sensor 107, the controller 109 and the wireless interface 111 of a sensor module 101a-d of the grid 100.

The luminaire 200 further comprises a light source 113 in the form of an LED array comprises a plurality of individual LEDs L1, . . . ,Ln. For instance, the LED array comprises 60 LEDs providing a total illumination of 2200 lm.

The luminaire 200, as shown in FIG. 2, further comprises a circuit board 201, e.g. a PCT board. The sensors 103, 105, 107 and the controller 109 can be placed on the circuit board. Preferably, as shown in FIG. 2, also the light source 113 and the wireless interface 111 is placed on the circuit board.

Preferably, the sensors 103, 105, 107 and the controller 109 are arranged within a housing (not shown) of the luminaire 200, e.g. below a diffusing plate. In this way, the sensors are not protruding the visible interface and do not disturb the appearance of the luminaire.

The luminaire 200 can further comprise a power supply 203, in particular a low voltage power supply (LOPS), which is arranged to provide a power supply to the light source 113, the sensors 103, 105, 107, the controller 109 and/or the wireless interface 111.

The luminaire 200 in FIG. 2 further comprises a driver 205, in particular a driver on board (DOB) for the light source 113.

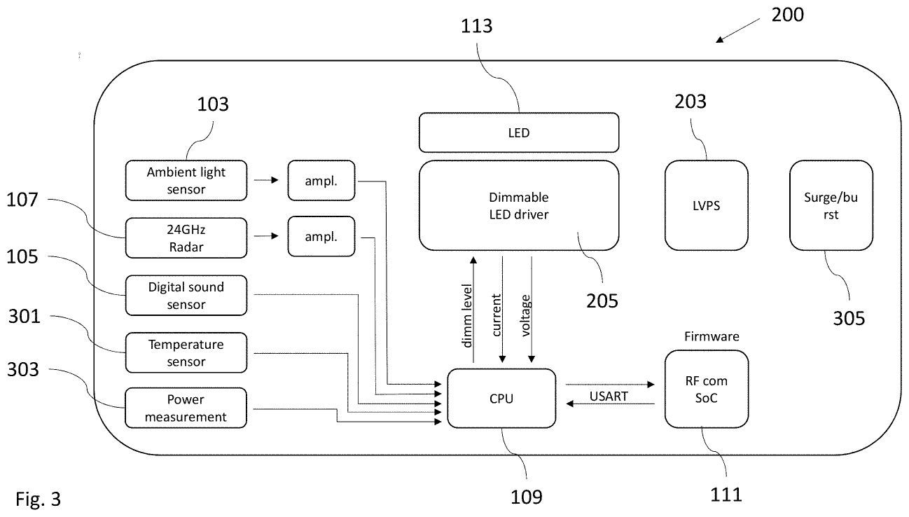

FIG. 3 shows a schematic diagram of the luminaire 200 according to a further embodiment. In particular, FIG. 3 shows a further exemplary embodiment of a luminaire 200 with an integrated sensor module 101a-d.

The luminaire 200, as shown in FIG. 3, comprises the light sensor 103, the motion sensor 107 in form of a 24 GHz radar sensor and the acoustic sensor 105 in form of a digital sound sensor.

The luminaire 200 further comprises a temperature sensor 301 and a power measurement unit 303, e.g. for measuring a power consumption by the luminaire 200.

Furthermore, the luminaire 200 can comprises a vibration sensor (not shown), e.g. for detecting vibrations in the ceiling.

Preferably, the sensors 103, 105, 107, 301 and 303 are configured to forward sensor values to the controller 109. In FIG. 3, the controller comprises a CPU.

The sensor values can comprise amplitudes of a detected signals, for instance, a brightness value detected by the light sensor 103 or a velocity of a movement detected by the motion sensor.

The luminaire 200, as shown in FIG. 3 comprises a dimmable LED driver 205 connected to the light source 113, wherein the light source 113 comprises LEDs. The controller 109 can be configured to control a dim level of the light source 113. The controller 109 can further be configured to receive information on a current voltage or current consumption of the LEDs.

The wireless interface 111 can be configured to communicate with the controller 109 via the USART (Universal Synchronous/Asynchronous Receiver Transmitter) protocol.

The wireless interface 111 can be integrated in the luminaire 200 as a system on a chip (SoC).

The luminaire can further comprise a surge/burst protection unit 305.

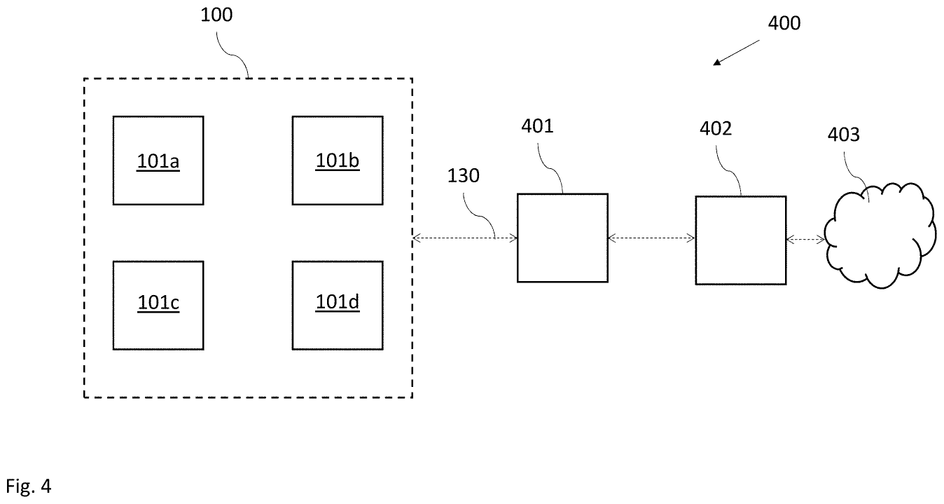

FIG. 4 shows a schematic diagram of a system 400 comprising the grid 100 of sensor modules 101a-d according to an embodiment. In particular, the grid 100 of the system 400 shown in FIG. 4 corresponds to the grid 100 shown in FIG. 1.

The system 400 further comprises the gateway 401, the data processing unit 402 and the central database 403.

The system 400 can further comprise a plurality of luminaires, in particular a luminaire grid, wherein each of the plurality of luminaires comprises a sensor module 101a-d of the gird 100.

Preferably, the interface 111 of each one of the sensor modules 101a-d in the grid 100 is configured to forward sensor information signals from the sensors 103, 105, 107 of the respective sensor module 101a-d to the gateway 401.

The gateway 401 can be configured to forward the sensor information signals to the central database 403. Preferably, the gateway is a wireless gateway.

The data processing unit 402 can be a computer. The data processing unit 402 can be

The central database 403 can be a memory of the data-processing unit or of another device. Alternatively, the central database 403 can be a cloud storage.

Preferably, the central database 403, in particular the sensor information signals stored in the central database 403, can be analyzed for evaluating the time development of one or more sensor information signals, in particular by the data processing unit.

Preferably, the data processing unit 402 and/or the central database 403 carry out a first data analysis, preferably by machine learning, for evaluating correlations between sensor information signals 130 of sensors 103, 105, 107 of different categories and/or of different sensor modules 101a-d.

Further, the data processing unit 402 and/or the central database 403 can carry out a second data analysis for evaluating the time development of one or more sensor information signals 130.

In particular, the central database 403 can be analyzed, preferably by the processing unit 402, for evaluating the correlations between sensor information signals of sensors 103, 105, 107 of different categories and/or different luminaires and/or for evaluating the time development of the one or more sensor information signals 130.

The system 400 is designed to adapt an operation parameter of the system 400 depending on the results of the first and/or second data analysis.

For instance, the system 400 is designed to detect incorrect data provided by one or more sensors 103, 105, 107 based on the first and/or second data analysis, and to ignore, replace or correct such incorrect data.

For example, the system 400 is designed to detect incorrect data, e.g. incorrect sensor values/readings, based on a deviation of the sensor values from a sensor 103, 105, 107 from an average of the sensor values of other (adjacent) sensors by more than a threshold value.

Alternatively, the system 400 may detect the incorrect data based on a standard deviation of the sensor values, e.g. over a certain period of time, from one sensor 103, 105, 107 is smaller than a threshold value. In other words, the system 400 detects incorrect data/readings from a sensor 103, 105, 107 if the sensor signal is too stable.

Further, the system 400 may detect the incorrect data if the course of the sensor signal over time is identified as irregular due to, e.g., too little change of the sensor signal over time. This detection can, for example, be carried out by a trained neural network or other artificial network. The trained neural network or artificial network can be implemented in the processing unit 402 and/or the central database 403.

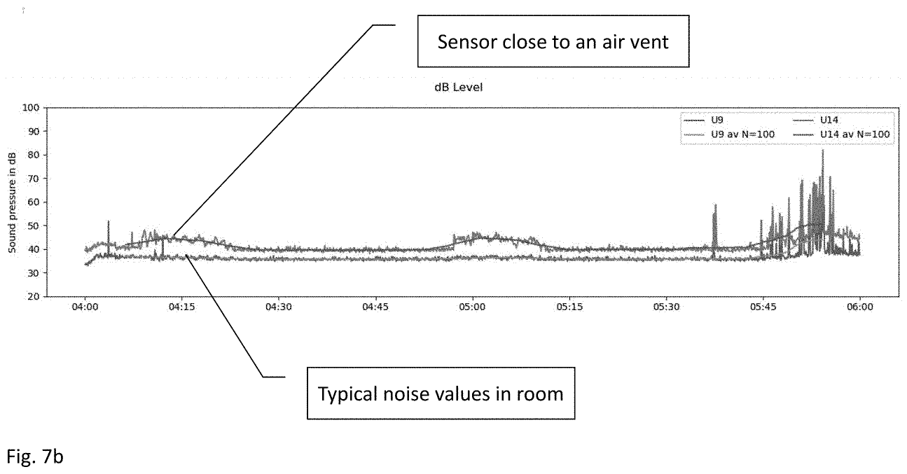

FIGS. 7a and 7b shows examples for sensor values, which comprise incorrect data to be corrected according to embodiments.

For example, FIG. 7a shows the amplitudes of sensor signals from several acoustic sensors 105 recorded over a time of several hours. These sensor signals comprise several features that can be detected as incorrect readings, such as extreme values, i.e. strong deviation from the average, regions with low standard deviation and non-proportional changes of some sensor values compared to the average of neighboring sensors.

By analyzing the signals shown in FIG. 7, the various incorrect signal values can be detected and, subsequently, ignored, replaced or corrected by the system 400. Furthermore, failing sensors 103, 105, 107 can be detected in this way.

FIG. 7b shows sensor readings from two different acoustic sensors 105. One of the two sensors is arranged close to an air vent, which causes signal anomalies in the form of a periodic increase of the sensor signal. By comparing both sensor signals, the anomalies can be detected and removed. Such an analysis is, for instance, carried out by the system 400 during a silent period, e.g. at night.

The system 400 can be configured to collect and analyze time series data collected from all sensors within a certain group of luminaires. For example, luminaires which are arranged within a room or rooms, or luminaires for which the neighbors are known. Anomalies in the time series data can be found by analyzing said data via a machine learning algorithm.

The machine learning algorithm can be trained to detect individual sensors for which the time series of their readings does not follow a regular pattern, or individual sensors giving significantly different values in the time series than neighboring sensors in the same time series. For example, a branching point in time at which the sensor values start to differ can indicate an anomaly.

The system 400 can further be designed to provide data of the system 400, in particular results of the first and/or second data analysis, to an external system, e.g. a building management system, a HVAC system, other a non-lighting system.

For instance, the system provides a presence function to an alarm system. The system can further provide an evaluation of a flow of people in the environment, e.g. in a shopping center. The system 400 could also be used for traffic monitoring, e.g. accident detection or adaptive control of traffic lights.

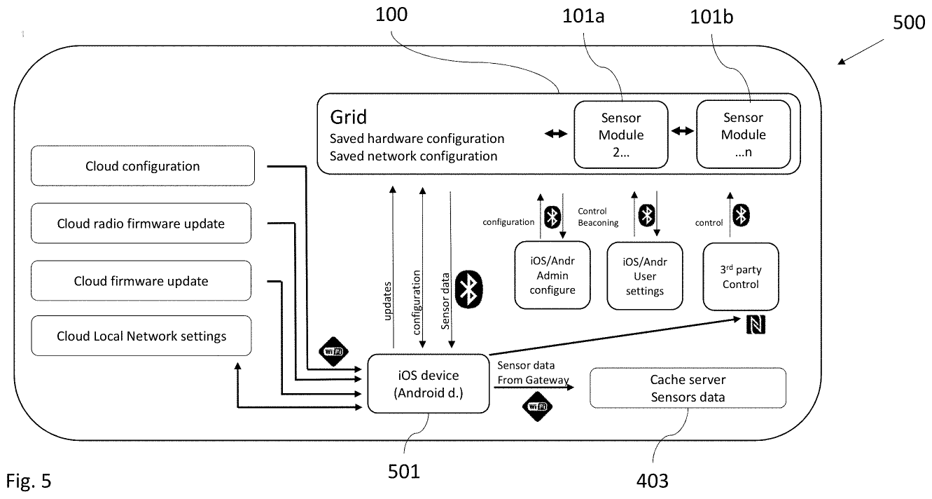

FIG. 5 shows a schematic diagram of a system 500 comprising the grid 100 of building technology sensor modules 101a-b according to a further embodiment. In particular, the system 500 shown in FIG. 5 corresponds to the system 400 shown in FIG. 4.

The system 500 shown in FIG. 5 comprises the grid 100, the central database 403 and a communication device 501, in particular a smartphone. The communication device 501 can be configured to establish a communication connection, in particular a Bluetooth connection, with the wireless interfaces 111 of the sensor modules 101a-d of the grid 100.

The grid 100 can be configured to receive update data, such as cloud (radio) firmware updates, and/or configuration data, such as user settings or local network settings, from the communication device 501.

The grid 100 can further be configured to forward configuration and/or sensor data to the communication device 501. The communication device 501 can be configured to forward this data, in particular the sensor data, to the central database 403, e.g. a cache server.

In a preferred embodiment, the communication device 501 may be configured to forward the configuration and/or sensor data to the wireless gateway 401. In an alternative embodiment, the communication device 501 may correspond to the wireless gateway 401.

The communication device 501 can be configured to initially receive the configuration and update data from an external source, e.g. via a WiFi connection.

The communication device 501 can further be configured to initiate a third parity control of the grid 100, e.g. by providing a third party device with necessary credentials via NFC.

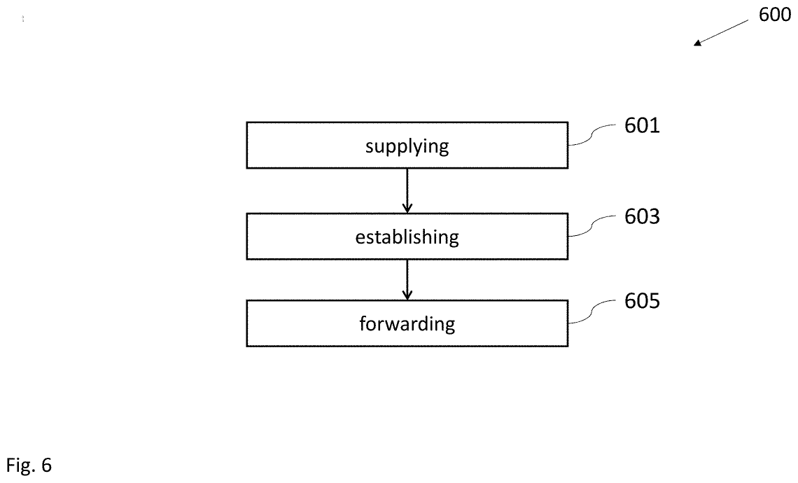

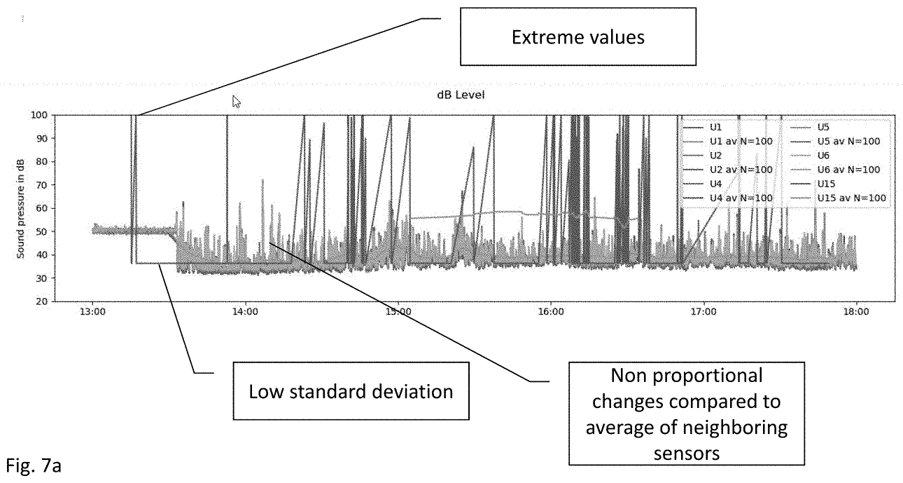

FIG. 6 shows a schematic diagram of a method 600 for operating a grid of a plurality of building technology sensor modules 101a-d according to an embodiment.

In particular, particular the building technology sensor modules 101a-d correspond to the sensor modules 101a-d as depicted in FIG. 1. Each sensor module 101a-d comprises a light sensor 103, preferably a daylight sensor, an acoustic sensor 105, and a motion sensor (107),

The method 600 comprises the steps of:

supplying 601 output signals of said sensors 103, 105, 107 to the controller 109,

establishing 603 a communication connection between the controller 109 and the gateway 401, and

forwarding sensor information signals (130) to the data processing unit 402 and/or the central database 403 by means of the gateway 401.

Preferably, the data processing unit and/or the central database carry out a first data analysis of the forwarded sensor information signals, e.g. by machine learning, for evaluating correlations between sensor information signals of sensors of different categories and/or of different sensor modules, wherein the system is designed to detect incorrect data provided by one or more sensors based on the first data analysis, and to ignore, replace or correct such incorrect data.

All features of all embodiments described, shown and/or claimed herein can be combined with each other.

While various embodiments of the present invention have been described above, it should be understood that they have been presented by way of example only and not limitation. Numerous changes to the disclosed embodiments can be made in accordance with the disclosure herein without departing from the spirit of scope of the invention. Thus, the breadth and scope of the present invention should not be limited by any of the above-described embodiments. Rather, the scope of the invention should be defined in accordance with the following claims and their equivalence.

Although the invention has been illustrated and described with respect to one or more implementations, equivalent alternations and modifications will occur to those skilled in the art upon the reading of the understanding of the specification and the annexed drawings. In addition, while a particular feature of the invention may have been disclosed with respect to only one of the several implementations, such features may be combined with one or more other features of the other implementations as may be desired and advantage for any given or particular application.

1. A system (400) comprising:
a data processing unit (402) and/or a central database (403); and
a grid (100) of a plurality of building technology sensor modules (101a-d), each of the sensor modules (101a-d) comprising:
a light sensor (103), preferably a daylight sensor,
an acoustic sensor (105),
a motion sensor (107),
a controller (109) which is configured to receive output signals from said sensors (103, 105, 107), and
an interface, preferably a wireless interface (111), for a communication between the controller (109) and a gateway (401) for forwarding sensor information signals (130) to the data processing unit (402) and/or the central database (403), wherein said sensor information signals (130) comprise a timestamp, an identifier of a sensor module (101a-d) and a sensor value;
wherein the data processing unit (402) and/or the central database (403) carry out a first data analysis of the forwarded sensor information signals (130), preferably by machine learning, for evaluating correlations between sensor information signals (130) of sensors (103, 105, 107) of different categories and/or of different sensor modules (101a-d); and
wherein the system (400) is designed to detect incorrect data provided by one or more sensors (103, 105, 107) based on the first data analysis, and to ignore, replace or correct such incorrect data.

2. The system (400) of claim 1, wherein the grid (100) further comprises luminaires (200), wherein one, more or all of the sensor modules (101a-d) are integrated in or associated with the luminaires (200).

3. The system (400) of claim 2, wherein the sensors (103, 105, 107) and the respective controllers (109) of the one, more or all sensor modules are placed on circuit boards (201) of the luminaires (200), wherein preferably the circuit boards (201) are provided with a plurality of LEDs (113, L1, . . . ,Ln).

4. The system (400) of claim 2, wherein the sensors (103, 105, 107) and the controllers (109) of the one, more or all sensor modules are arranged within housings of the luminaires (200), preferably below diffusing plates.

5. The system (400) of claim 2, wherein the luminaires are downlights, pending luminaires and/or a freestanding luminaires.

6. The system (400) of claim 1, wherein the controller (109) is arranged for forwarding the sensor information signals (130) repetitively with a constant or a varying frequency.

7. The system (400) of claim 1, wherein the sensor value represents a parameter value of the output signal at the time of the associated timestamp.

8. The system (400) of claim 1, wherein the interface is configured to forward said sensor information signals (130) using a communication protocol comprising, the Bluetooth standard, the ZigBee standard or the Thread standard.

9. The system (400) of claim 1, wherein the data processing unit (402) and/or the central database (403) carry out a second data analysis of the forwarded sensor information signals (130) for evaluating the time development of one or more sensor information signals (130).

10. The system (400) of claim 9, wherein the system (400) is designed to adapt an operation parameter of the system (400) depending on the results of the first and/or second data analysis.

11. The system (400) of claim 1, wherein the system (400) is designed to provide data of the system (400) to an external system, e.g. a building management system, a HVAC system, or a non-lighting system.

12. The system (400) of claim 1, wherein the central database (403) comprises a local storage, which is arranged in an environment of the grid (100) and/or a remote storage, e.g. a cache server or a cloud storage.

13. A method (600) for operating a grid (100) of a plurality of building technology sensor modules (101a-d), each of the sensor modules (101a-d) comprising:
a light sensor (103), preferably a daylight sensor,
an acoustic sensor (105),
a motion sensor (107),
a controller (109), and an interface, preferably a wireless interface (111);
the method (600) comprising the steps of:
supplying (601) output signals of said sensors (103, 105, 107) to the controller (109),
establishing (603) a communication connection between the controller (109) and a gateway (401) via the interface, and
forwarding (605) sensor information signals (130) to a data processing unit (402) and/or a central database (403) by means of the gateway, wherein said sensor information signals (130) comprise a timestamp, an identifier of a sensor module (101a-d) and a sensor value;
wherein the data processing unit (402) and/or the central database (403) carry out a first data analysis of the forwarded sensor information signals (130), preferably by machine learning, for evaluating correlations between sensor information signals (130) of sensors (103, 105, 107) of different categories and/or of different sensor modules (101a-d), and
wherein the system (400) is designed to detect incorrect data provided by one or more sensors (103, 105, 107) based on the first data analysis, and to ignore, replace or correct such incorrect data.

14. The system (400) claim 1, wherein the controller (109) is arranged for forwarding the sensor information signals (130) repetitively with a constant or an adaptive frequency.

15. The system (400) claim 1, wherein the sensor value represents an amplitude of the output signal at the time of the associated timestamp.
